(19) United States
(12) Patent Application Publication
(10) Pub. No.: US 2009/0132387 A1
(43) Pub. Date: May 21, 2009

(54) Online gifting

(76) Inventor: Muntaser Majdoub, Burlingame, CA (US)

Correspondence Address: Ashok Tankha;Of Counsel, Lipton, Weinberger & Husick, 36 Greenleigh Drive, Sewell, NJ, 08080, US

(21) Appl. No.: 11/986,054

(22) Filed: Nov. 20, 2007

(51) Int. Cl. G06Q 30/00; G06Q 20/00

(52) U.S. Cl. 705/27; 705/26

(57) ABSTRACT

The computer implemented method and system disclosed herein enables gifting a recipient on a social occasion in an online gifting environment of a provider. A user creates a virtual session for the social occasion in the online gifting environment. A business relation exists between the online stores and the provider, thereby enabling the user to search for gifts from multiple online stores. The user creates gift packages using the gifts selected from the online stores. The user invites guests to participate in the virtual session. The guests and the user post virtual greetings to the recipient in the virtual session. The guests contribute funds for purchase of at least one of the gift packages. The provider selects and purchases at least one of the gift packages based on the total funds contributed by the guests. The purchased gift packages are then delivered to the recipient on the social occasion.

### BACKGROUND

This invention, in general, relates to group gifting. More particularly, this invention relates to gifting a recipient on a social occasion by multiple guests in an online gifting environment.

People give gifts to others on different social occasions. When a person buys a gift, the person may not always know what gifts are preferred by the beneficiary. Thus, many a times, people buy gifts that are not of much use to a beneficiary. The person may also not be able to spend a large amount of money on the gift. The trend these days has shifted towards group gifting. Group gifting allows a group of people to collectively purchase a gift for a beneficiary. Group gifting thereby enables buying of valuable and useful gifts. However, in group gifting, it may be difficult to coordinate with the entire group to collect money and purchase the gift. Moreover, every member in the group may not be able to pay an equal share in the purchase of the gift due to financial constraints. The group of people may also not be able to decide on a suitable gift for the beneficiary.

Therefore, there is a need to coordinate a group of people for an occasion, collect money from the group, and purchase a preferred gift. Moreover, there is a need for searching and selecting a variety of gifts and sending greetings to the beneficiary on the social occasion. Hence, there is an unmet need for a method and system to gift a recipient on a social occasion by multiple guests in an online gifting environment of a provider.

### SUMMARY OF THE INVENTION

The computer implemented method and system disclosed herein addresses the above stated needs for gifting a recipient on a social occasion in an online gifting environment of a provider. A user creates a virtual session for the social occasion in the online gifting environment. The user provides name of the recipient, relationship shared with the recipient, address of the recipient, type of the social occasion, date of the social occasion, and end date for contribution of funds by guests for creation of the virtual session. The user also posts a message for the guests to view. The message may be a text message, a multimedia message, and a combination thereof. The user searches for gifts for the recipient from multiple online stores for creation of multiple gift packages. A business relation exists between the online stores and the provider of the online gifting environment, thereby enabling the user to search for gifts from a variety of online stores in the virtual session. The user then creates the gift packages using the gifts selected from the online stores. Further, the user prioritizes the gifts and gift packages to be purchased by the provider based on preferences of the recipient.

The user invites a number of guests to participate in the virtual session. The user sends an electronic mail (email) to the email accounts of the guests to invite the guests to participate in the virtual session. The guests and the user post virtual greetings to the recipient in the virtual session. The virtual greetings may be text greetings, picture greetings, or multimedia greetings. The guests contribute funds for purchase of at least one of the gift packages. The virtual session encompasses a meter bar. The meter bar displays the total funds contributed by the guests for purchase of one of the gift packages to the recipient. At least one of the gift packages is selected from the multiple gift packages based on the total funds contributed by the guests. The provider of the online gifting environment purchases the selected gift packages. The purchased gift packages are then delivered to the recipient on the social occasion.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of gifting a recipient on a social occasion in an online gifting environment of a provider.

FIG. 2 illustrates a system for gifting a recipient on a social occasion in an online gifting environment of a provider.

FIG. 3A exemplarily illustrates the steps involved in gifting a recipient on a social occasion in an online gifting environment of a provider.

FIG. 3B exemplarily illustrates the creation of a virtual session by a user in an online gifting environment.

FIG. 3C exemplarily illustrates the search for gifts and creation of gift packages by a user.

FIG. 3D exemplarily illustrates a meter bar representing total funds contributed by the guests in a virtual session.

FIG. 3E exemplarily illustrates the process of inviting guests to participate in a virtual session.

FIGS. 3F-3H exemplarily illustrate the process of adding gifts to a preference list.

FIG. 4A exemplarily illustrates an account of a user in an online gifting environment.

FIG. 4B exemplarily illustrates a virtual session created by a user.

### DETAILED DESCRIPTION OF THE INVENTION

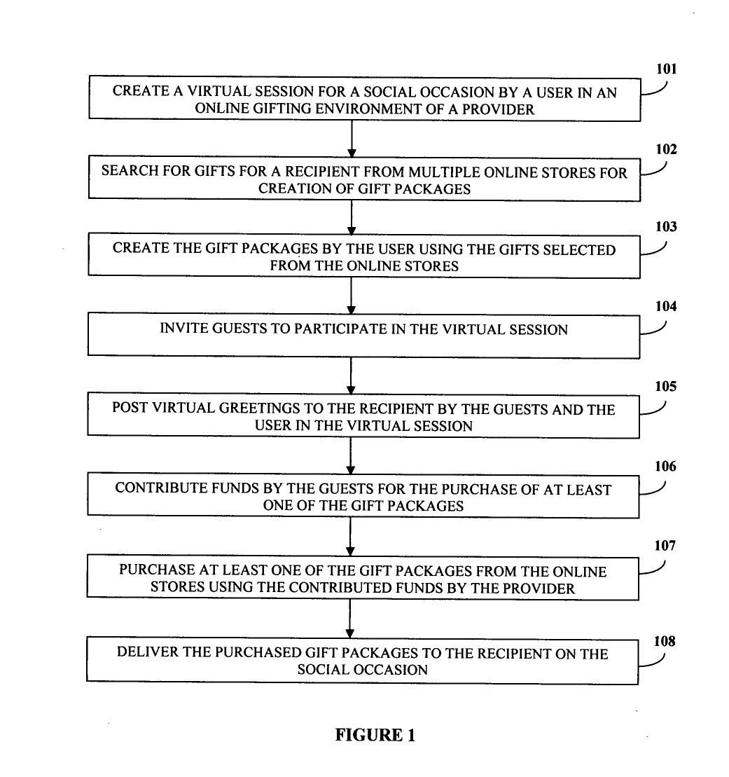

FIG. 1 illustrates a method of gifting a recipient on a social occasion in an online gifting environment 204 of a provider. A user 200 may create 101 a virtual session for the social occasion in the online gifting environment 204. The user 200 may provide name of the recipient, relationship shared with the recipient, address of the recipient, type of the social occasion, date of the social occasion, and end date for contribution of finds by guests for creation of the virtual session. The end date signifies the last date for contribution of funds by the guests for purchase of gift packages. The social occasion may be, for example, a birthday, father's day, mother's day, graduation, Christmas, Hanukah, a wedding, an anniversary, Valentine's day, a house warming, a Bar Mitzvah, etc. Consider an example of a user 200 creating a virtual session. The user 200, Peter, may create a virtual session for his son Tom's birthday in the online gifting environment 204. Peter may enter Tom's name, Tom's address, date of Tom's birthday, and the end date for contribution of finds by guests for Tom's gift.

The user 200 may also post a message for the guests in the virtual session. The message may be a text message, a multimedia message, or a combination thereof. The message posted by the user 200 may be a text message inviting the guests to attend the celebration of the social occasion. The user 200 may also upload a multimedia message such as a video requesting the guests to contribute for the purchase of the gift packages or a video of the recipient. For example, Peter may post a text message such as, “Hi! It's my son's birthday and he is 14. Everyone is invited to a party at our house on the 20^{th} of October. Here is a list of what he would really love to have for his birthday”. Peter may also upload a video letting the guests know what Tom may want for his birthday or talk about how he plans to celebrate Tom's birthday. Peter may also upload a home video of Tom in the virtual session.

The user 200 may search 102 for gifts for the recipient from multiple online stores for creation of multiple gift packages. A business relation may exist between the online stores and the provider of the online gifting environment 204, thereby enabling the user 200 to find gifts from a variety of online stores in the virtual session. The user 200 may select gifts from the variety of online stores, thereby creating an assortment of gifts preferred by the recipient. The gifts may be products, services, gift checks, gift coupons, etc. The user 200 may then create 103 the gift packages using the gifts selected from the online stores. Further, the user 200 may prioritize the gifts and gift packages to be purchased by the provider based on preferences of the recipient. For example, Tom may want either a scooter or a board game and a book for his birthday. Peter may select the scooter from an online toy store and create a first gift package comprising the scooter to be purchased by the provider. Peter may select the board game and the book from the online toy store and an online bookstore respectively to create a second gift package comprising the board game and the book to be purchased by the provider. Peter may also create a third gift package comprising a video game and two video game cartridges. If Tom prefers the scooter as a gift for his birthday, the Peter may give higher priority to the first gift package.

The user 200 may invite 104 a number of guests to participate in the virtual session. The user 200 may send an electronic mail (email) to the email accounts of the guests to invite the guests to participate in the virtual session. For example, Peter may invite his family members, his friends, and Tom's friends to participate in the virtual session by sending them an email. Email addresses of the email accounts of the guests may be manually entered by the user 200 in the virtual session. The email addresses of the email accounts of the guests may also be fetched from an online address book of an email account of the user 200. The email account of the user 200 may be an email account on any one of email clients such as Google Mail™, Yahoo!®, AOL™, Hotmail®, etc. The user 200 may use other means for sending invitations to the guests such as text short messaging service (SMS) messages, multimedia messaging service messages, etc. The guests and the user 200 may post 105 virtual greetings to the recipient in the virtual session. The virtual greetings may be text greetings, picture greetings, and multimedia greetings. The guests and the user 200 therefore personalize the virtual session for the recipient by posting virtual greetings for the forthcoming social occasion. For example, Tom's family and friends may post text greetings to wish him for his birthday. Tom's friends may upload some pictures of Tom's earlier birthdays reminding him of good times spent during their younger days. Tom's cousins who live in a different state may upload a video of themselves wishing Tom on his birthday as they may not be able to join him at the party.

The guests may contribute 106 funds for purchase of at least one of the gift packages. The guests may contribute funds using a credit card or by making use of the PayPal™ option. PayPal™ is an electronic commerce business allowing users to make payments or transfer money through the internet. The virtual session may also encompass a meter bar 501 next to the display of the gift packages. The meter bar 501 displays a starting point representing null funds and an ending point representing the total price of all the gift packages. The meter bar 501 displays the total funds contributed by the guests for purchase of the gift packages by the provider. Each time a guest contributes funds, the meter bar 501 displays a rise in the funds and displays the new total of the funds contributed by the guests. The meter is displayed alongside the gift packages, and hence when the meter bar 501 displays a rise, the meter bar reflects one of the gift packages with the price range closest to the total funds contributed by the guests. The user 200 may also prioritize the gift packages and set the most preferred items at the bottom of the meter bar. Names of the guests who contributed funds and the funds contributed by each of the guests may also be displayed alongside the meter bar 501.

The provider of the online gifting environment 204 may select one of the gift packages from the multiple gift packages based on the total funds contributed by the guests. The provider may then purchase 107 the selected gift packages from the online stores. For example, the first gift package created by Peter may cost $250, the second gift package may cost $100, and the third gift package may cost $145. The gift packages are displayed in the increasing order of price alongside the meter bar 501. If Tom's family and friends contribute a total of $185, the third gift package comprising the video game and two video game cartridges is selected. The third gift package is purchased by the provider of the online gifting environment 204. A gift check of the balance amount of $40 is also included in the gift package. The purchased gift packages may then be delivered 108 to the recipient on the social occasion. In the example, the third gift package and the gift check are then mailed to Tom on the day of his birthday by the provider of the online gifting environment 204.

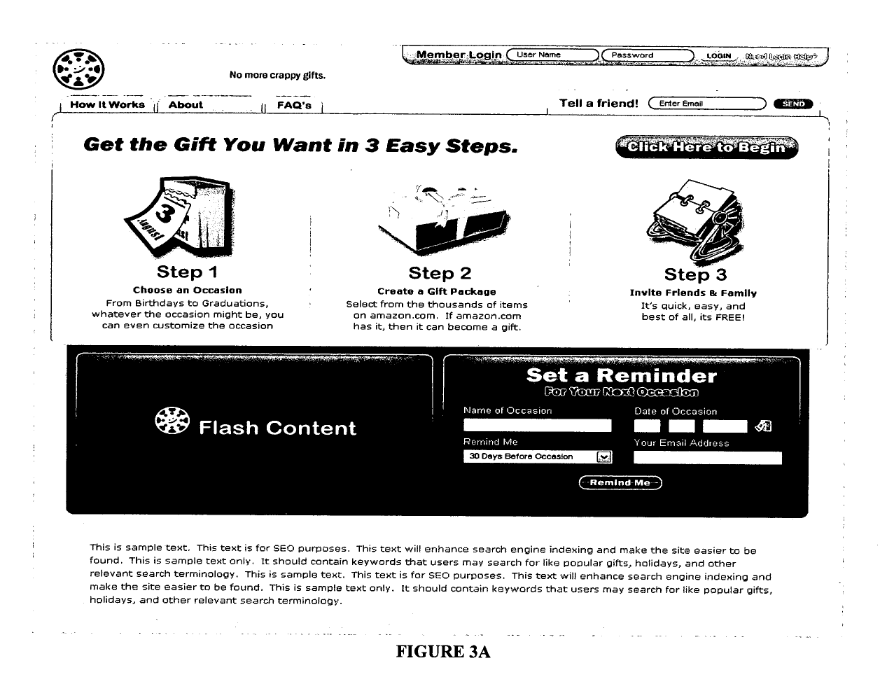

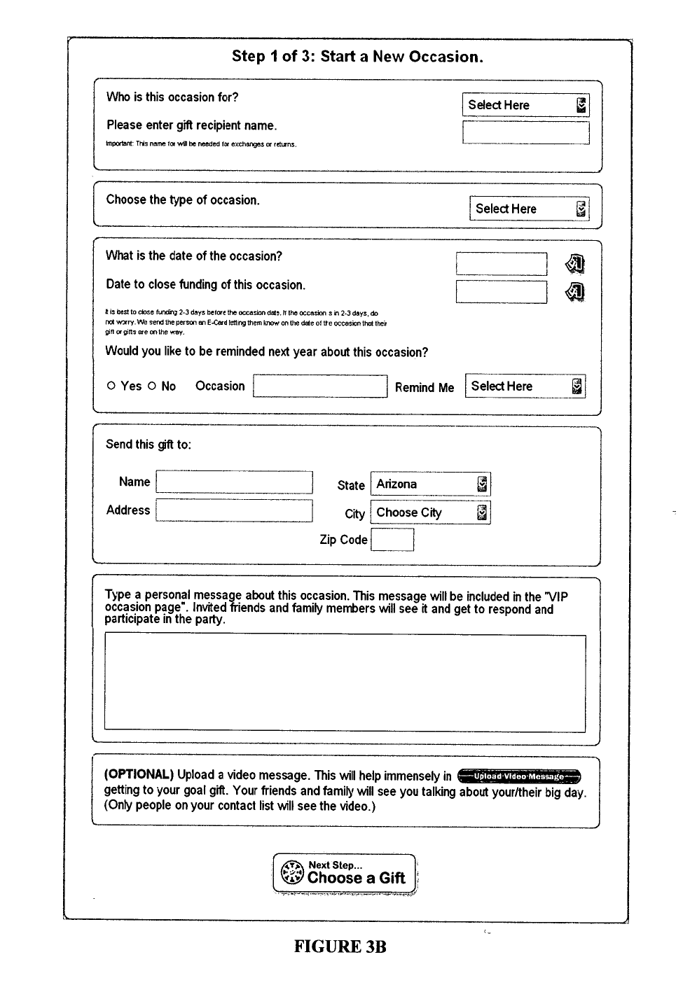

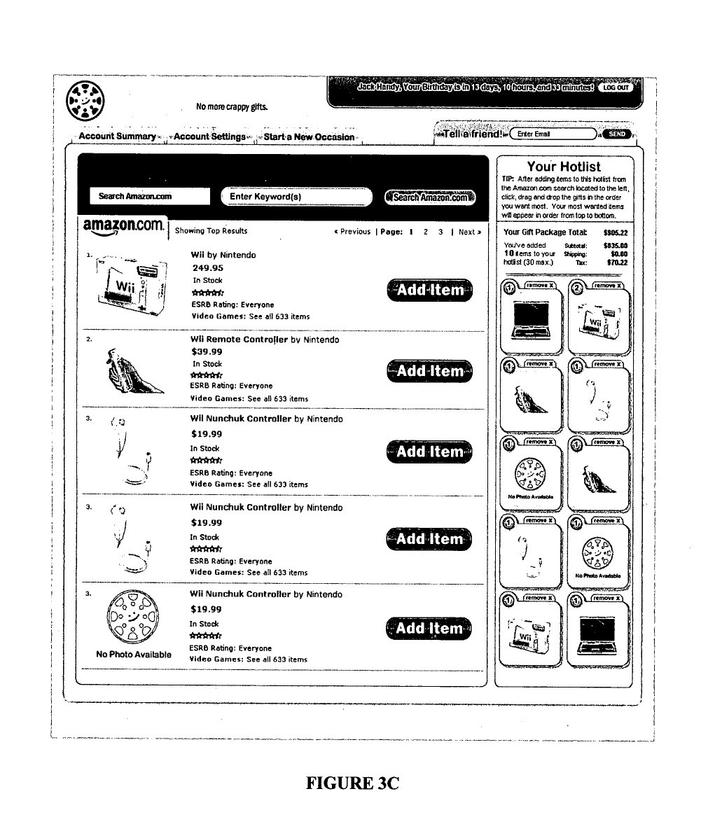

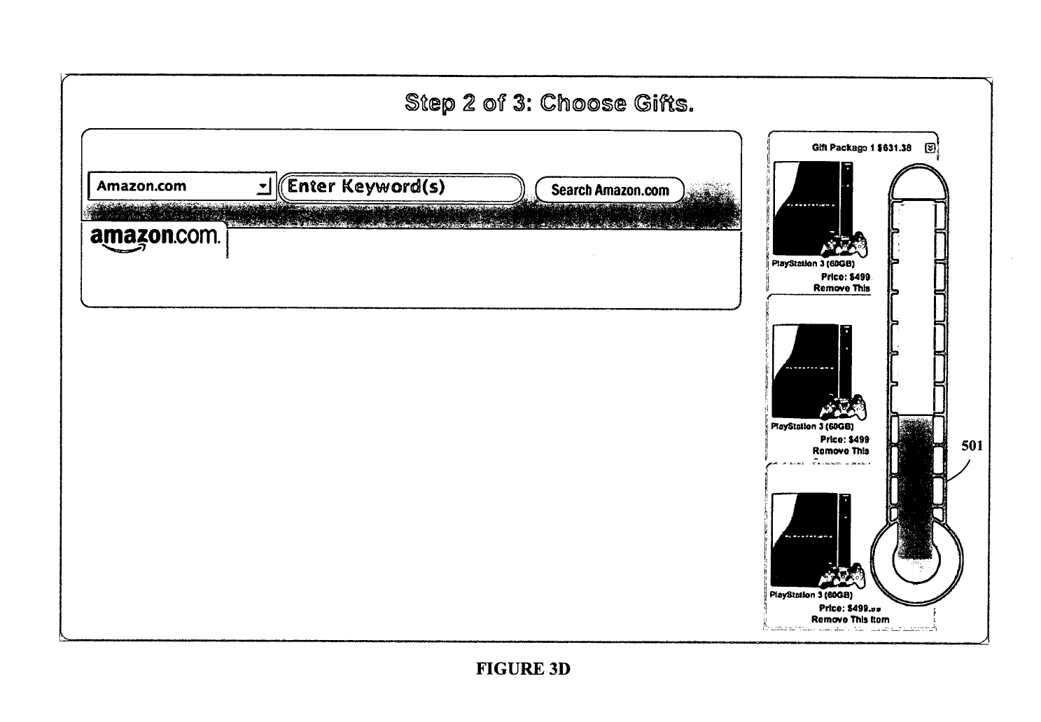

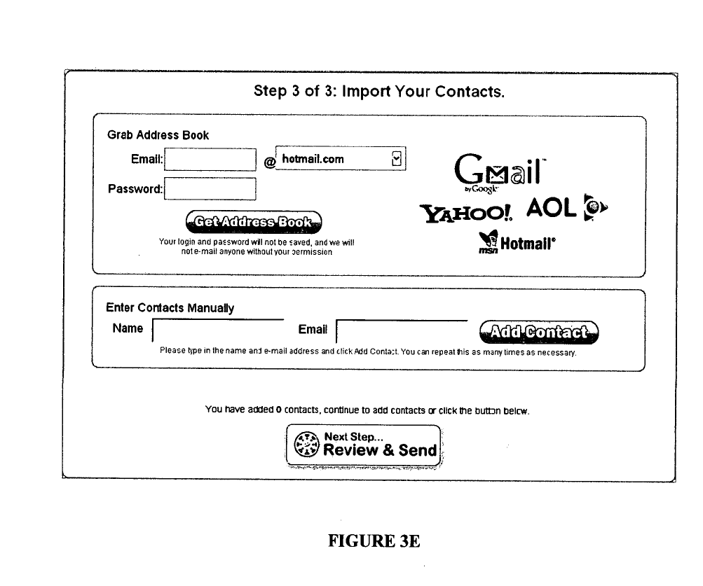

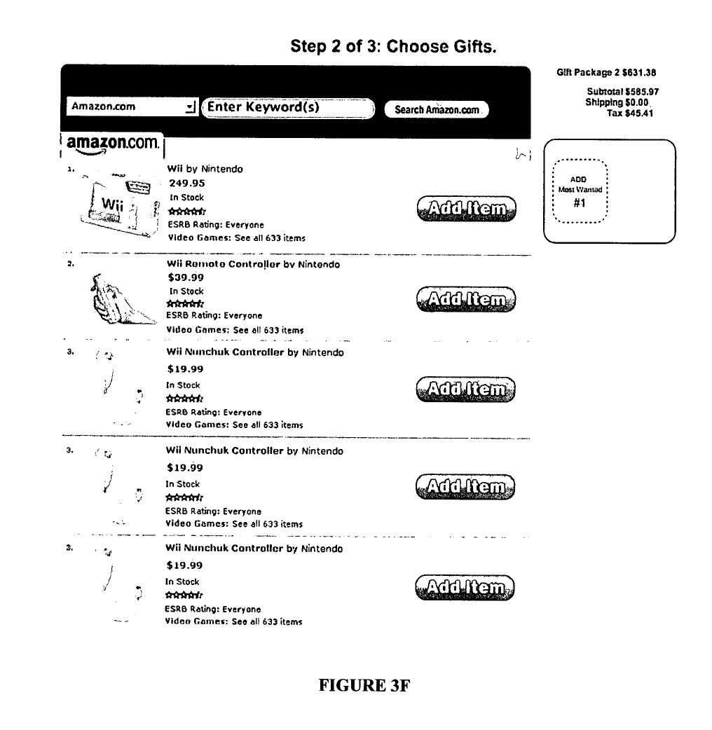

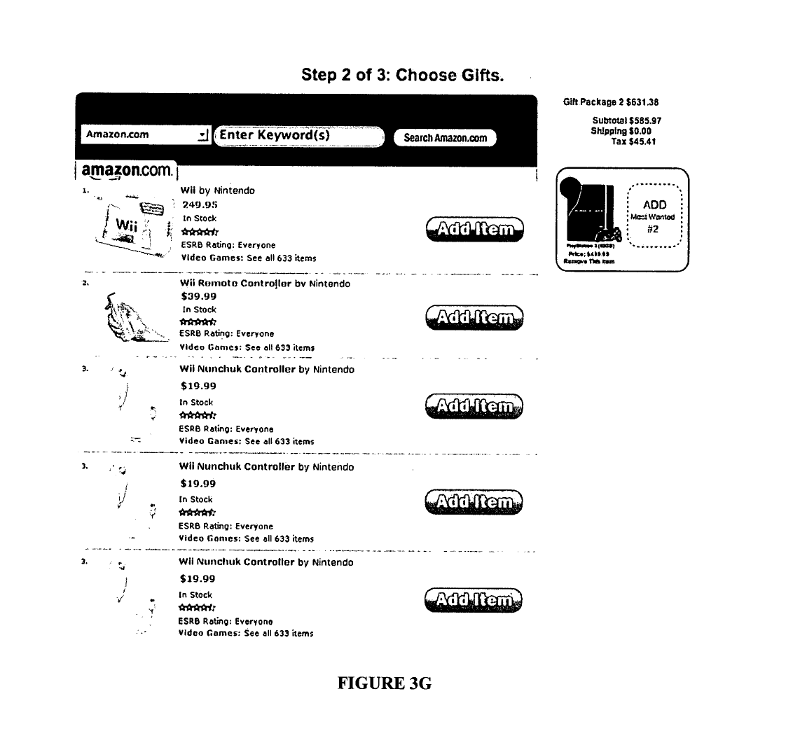

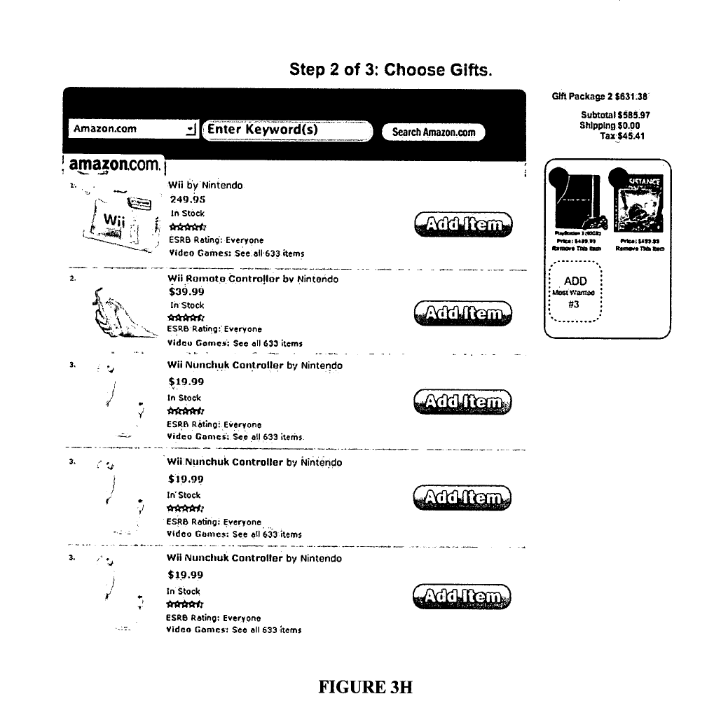

In another implementation, the user 200 may select multiple gifts for the recipient and store them in a preference list. The user 200 may prioritize the gifts in the order of preference starting from the most wanted gift to the least wanted gift. The virtual session also represents how popular the gift is. The more popular the gift, the higher up the gift is on the preference list. The user 200 may change the order of preference of the gifts at any given time. The user 200 may rearrange the gifts by dragging the most popular gift to a preferred position. The user 200 may drag for example a seventh preferred gift to the third position. The rearrangement of the gifts may be performed using the Asynchronous JavaScript and XML (AJAX) technology provided in the online gifting environment 204. AJAX is a web development technique used for creating interactive web applications. AJAX enables interaction by exchanging small amounts of data with a server in the online gifting environment 204. The use of AJAX avoids reloading the virtual session each time the user 200 makes a change to the virtual session. The gifts are arranged in the virtual session starting with the least preferred gift and moving downward towards the most preferred gift. The meter bar 501 may be displayed alongside the list of gifts. The meter bar 501 displays a rise in proportion to the funds contributed by the gifts. The gifts covered by the meter bar 501 are the gifts to be purchased by the provider due to sufficient total funds. The funds contributed by the guests will be used to buy the gifts in the order of preference, i.e. starting with the most preferred gift and going up towards the least preferred gift. The process of adding gifts to the preference list is exemplarily illustrated in FIGS. 3F-3H. As illustrated in FIG. 3F, the user 200 views an empty slot alongside the search engine 202b and an option to “add items” to the empty slot. Once the user 200 has searched and selected the gift to be added, the user 200 clicks the “add item” button provided next to the gift. Numbers displayed alongside the selected gift represent how popular the gift is in the preference list. Number one represents the most preferred gift, number two represents the next preferred gift, etc.

In another implementation, the guests may offer suggestions to the user 200 regarding gifts to be selected for the recipient. The user 200 may conduct a poll in the virtual session allowing the guests to vote for one of the gifts listed by the user 200 in the virtual session. The user 200 may select the gifts with the majority of the votes of the guests. The user 200 may then create gift packages utilizing the selected gifts. The guests may then contribute funds to purchase the gift packages. For example, a user 200, Stanley may create a virtual session for his manager Mark on the occasion of Mark's birthday. Stanley may start a poll on the virtual session inviting his colleagues to vote for the gifts appropriate for Mark. Stanley may select the gifts with the majority votes. Stanley may then create gift packages comprising the selected gifts. Stanley and his colleagues may then contribute funds to purchase the gift packages for Mark. In another implementation, the guests may post messages for the user 200 on the virtual session. The messages may contain suggestions regarding gifts to be selected for the recipient. The user may create gift packages comprising gifts suggested by the guests.

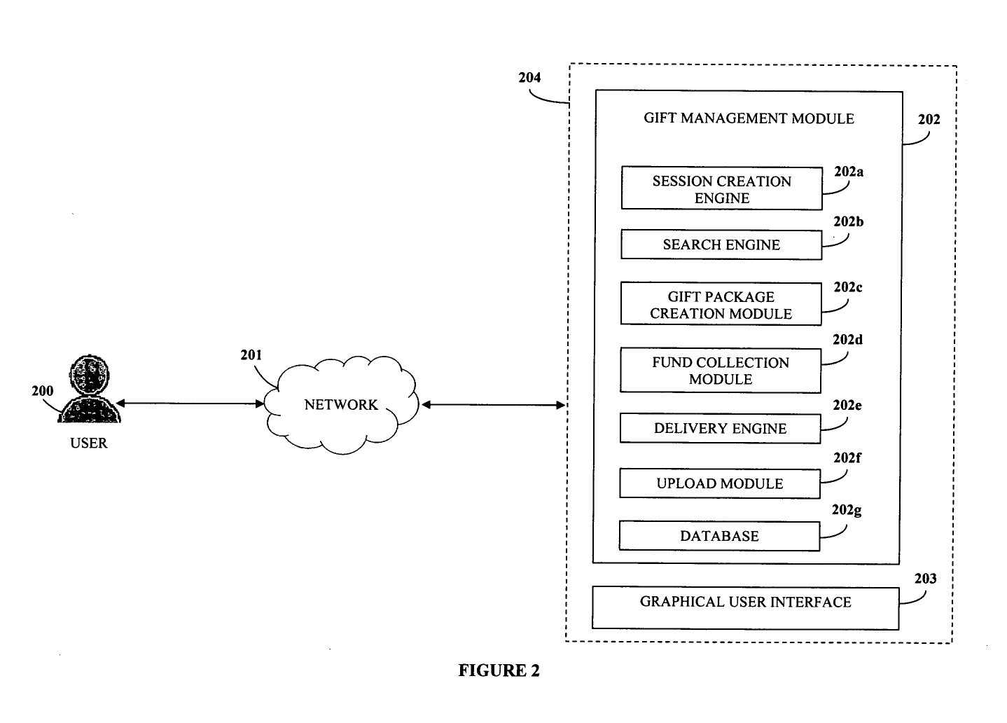

FIG. 2 illustrates a system for gifting a recipient on a social occasion in an online gifting environment 204 of a provider. The system disclosed herein comprises a gift management module 202 and a graphical user interface (GUI) 203. The gift management module 202 comprises a session creation engine 202a, a search engine 202b, a gift package creation module 202c, a fund collection module 202d, a delivery engine 202e, an upload module 202f, and a database 202g. A user 200 accesses the online gifting environment 204 via a network 201.

The user 200 may want to create a virtual session for the social occasion in the online gifting environment 204. The user 200 may provide name of the recipient, address of the recipient, date of the social occasion, and end date for contribution of finds by guests for creation of the virtual session. The session creation engine 202a utilizes the information provided by the user 200 and creates a virtual session in the online gifting environment 204. The user 200 may want to post a message for the guests in the virtual session. The message may be a text message, a multimedia message, or a combination of these. The upload module 202f enables the user 200 to upload the multimedia message in the virtual session.

The user 200 may search for gifts for the recipient utilizing the search engine 202b. The search engine 202b accepts keywords and conducts a search based on the keywords. The search engine 202b performs a search on a variety of online stores integrated into the online gifting environment 204. A business relation exists between the online stores and the provider of the online gifting environment 204, thereby enabling the user 200 to search for gifts from a variety of online stores in the virtual session. The online gifting environment 204 may use Amazon Web Services™ for the search. The search engine 202b automatically fetches product information based on the keywords entered instead of visiting the websites of the online stores.

The user 200 may want to create gift packages utilizing the gifts selected from the online stores. The gift package creation module 202c creates gift packages using the gifts selected from the online stores by the user 200. The gift package creation module 202c adds cost price of the gift, tax, and shipping charges to deliver the gift packages to the recipient and displays the total cost of the gift packages in the virtual session. The price of the gift, the tax, and the shipping charges are also displayed in the virtual session alongside each of the gift packages.

The user 200 may invite the guests to participate in the virtual session utilizing the GUI 203. The user 200 may enter email addresses of email accounts of the guests on the GUI 203. The guests and the user 200 may post virtual greetings to the recipient in the virtual session using the GUI 203. The virtual greetings may be text greetings, picture greetings, and multimedia greetings. The guests and the user 200 may upload picture greetings and multimedia greetings in the virtual session using the upload module 202f.

The guests contribute funds for purchase of one or more of the gift packages. The fund collection module 202d collects finds contributed by the guests for purchase of at least one of the gift packages and displays the total funds contributed using the meter bar 501. The funds contributed by each of the guests may also be displayed in the virtual session. The provider of the online gifting environment 204 may select the gift packages to be purchased based on the total funds contributed by the guests. The provider may purchase the gift packages to be delivered to the recipient on the social occasion. The delivery engine 202e enables delivery of the purchased gift packages to the recipient on the social occasion. The delivery engine 202e generates the mailing details of the recipient on request of the provider. The provider may then deliver the gift packages to the recipient on the social occasion. Further, the recipient may return or exchange the gift packages with the online stores. For example, if the recipient wants to return or exchange the gift packages purchased from Amazon.com®, Inc., the recipient may return the gift packages to Amazon.com®, Inc. In case of a return, Amazon.com®, Inc. refunds the provider of the online gifting environment 204. Subsequently, the provider returns the funds to the guests. Further, in case of an exchange, Amazon.com®, Inc. delivers the exchanged gift packages to the provider. The provider may then deliver the gift packages to the recipient. In another implementation, Amazon.com®, Inc. may directly deliver the exchanged gift packages to the recipient.

The database 202g stores account information of the user 200, information of the recipient, information on the social occasion and the created gift packages, information on the contributed funds, the virtual greetings, text messages, and multimedia messages uploaded by the guests and the user 200. The account information includes registration and login information of the user 200. The information of the recipient includes name and address of the recipient. The social occasion information includes type of the social occasion, date of the social occasion, and end date for contribution of finds by guests. The information on the created gift packages includes information on the gifts selected by the user 200 and price of the gifts. The contributed funds information includes the details of funds contributed by the guests and names of the guests contributing the funds.

FIG. 3A exemplarily illustrates the steps involved in gifting a recipient on a social occasion in an online gifting environment 204 of a provider. A user 200, Luke may want to create a virtual session for his friend Mandy on the occasion of her wedding. Luke may provide Mandy's name, the relationship Luke shares with Mandy, the social occasion being celebrated, the date of Mandy's wedding, the end date for contributions of funds by the guests, and the address to which the gift needs to be delivered. Luke may also post a message for the guests to view. Luke may post a text message with more information about the wedding such as the groom's name and the venue of the wedding. Luke may upload some videos of Mandy and her fiancé for the guests to view. Luke may also upload a video of himself talking about Mandy and her fiancé and the gifts that Mandy may want or need. The creation of a virtual session by Luke in an online gifting environment 204 is exemplarily illustrated in FIG. 3B.

Luke may now find gifts for Mandy from multiple online stores for creation of multiple gift packages. Luke may pick an assortment of gifts for Mandy from the online stores. Luke may search for and pick a cutlery set from an online crockery and cookware store and an oriental rug from an online furnishing store. Luke may create a first gift package comprising the cutlery set and the oriental rug. Luke may create a second gift package consisting of a ceramic wall plaque and a wooden clock from an online home accessories store. The total price of the first gift package may be $485 and of the second gift package may be $400. The search for gifts and creation of gift packages by Luke is exemplarily illustrated in FIG. 3C.

Luke may now invite Mandy's friends and family to participate in the virtual session. Luke may send an email to Mandy's friends and family inviting them to the virtual session. The process of inviting Mandy's friends and family to participate in the virtual session is exemplarily illustrated in FIG. 3E. Mandy's friends and family and Luke may post virtual greetings for Mandy and her fiancé in the virtual session. Mandy's friends and family may also contribute funds to purchase gift packages for Mandy. The gift packages created by Luke are displayed in the virtual session alongside a meter bar 501. The meter bar 501 represents the total finds contributed by the guests to buy gift packages for Mandy. FIG. 3D exemplarily illustrates a meter bar representing total funds contributed by the guests in a virtual session. The provider of the online gifting environment 204 checks the funds contributed by the guests on the end date for contribution and selects the gift package to be purchased for Mandy. If Mandy's friends and family contribute a total of $1000, the first and the second gift packages will be purchased by the provider for Mandy. Further, a gift check for the extra amount of $115 is drawn in Mandy's favor. The provider then delivers the first and second gift packages along with the gift check to Mandy on her wedding day.

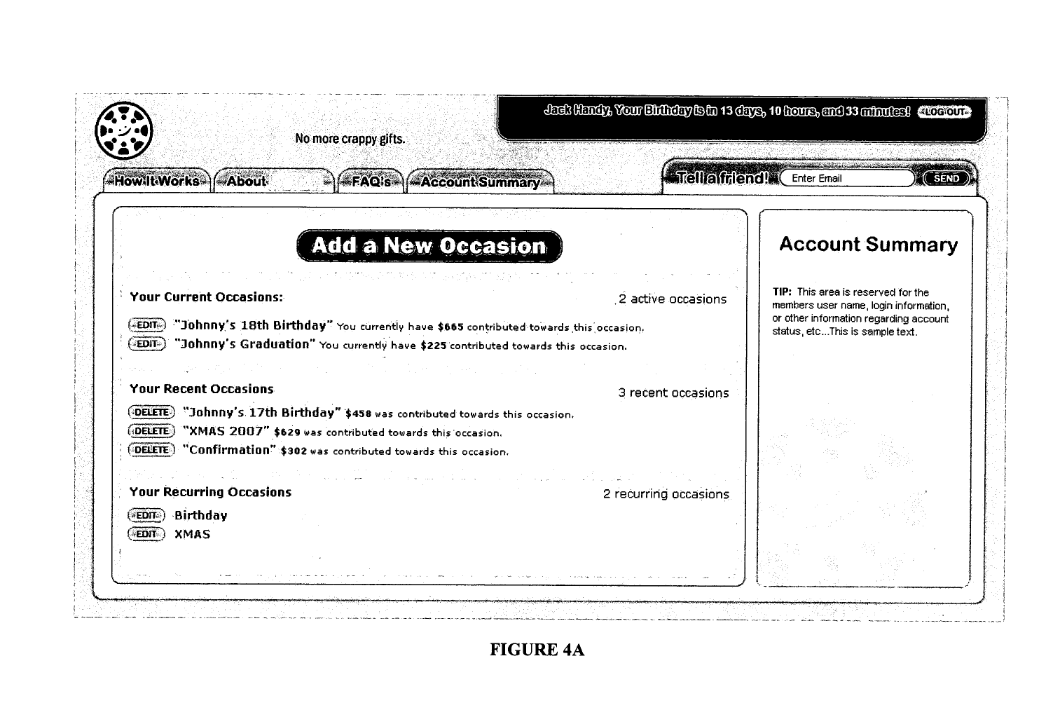

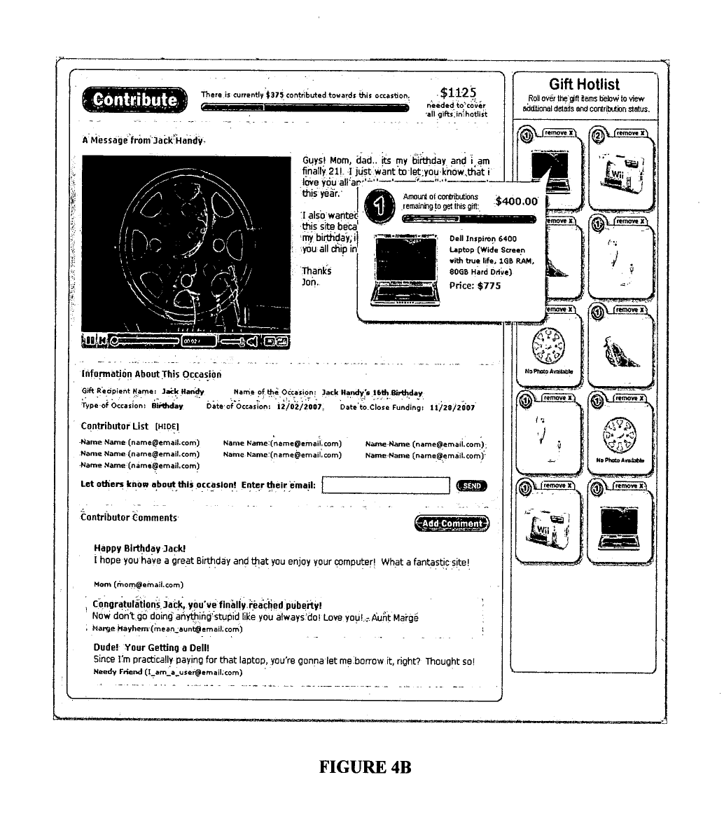

FIG. 4A exemplarily illustrates a user's account in the online gifting environment. The user 200 may create multiple virtual sessions for different social occasions. Consider an example of a user 200, Jack creating multiple virtual sessions in the online gifting environment 204. Jack's account will include information of the virtual sessions created by Jack on different social occasions. The social occasions may be categorized as current occasions, recent occasions, and recurring occasions. If the end date of a social occasion has not been reached, the social occasion is classified as a current occasion. A social occasion is categorized as a recent occasion if the end date of the social occasion has passed. Social occasions such as birthdays, Christmas, anniversaries, etc. that are celebrated annually may be classified as recurring occasions. Further, the user's 200 account includes information of the funds contributed by guests for each of the social occasions. The user's 200 account also includes an account summary section. The account summary section includes the user's 200 registration information and information regarding the status of the account. The user's 200 account also includes information of the duration of time remaining for the end date of the current occasion to be reached.

The user 200, Jack may create a virtual session for his 21^{st} birthday and invite his family and friends to participate in the virtual session. Jack's family and friends may contribute funds for the purchase of gift packages for Jack. Further, Jack's family and friends may post virtual greetings for Jack in the virtual session. The virtual session created by Jack is exemplarily illustrated in FIG. 4B. The virtual session displays the gift packages created by Jack, a message uploaded by Jack for Jack's family and friends, information about the social occasion, the virtual greetings posted by Jack's family and friends, a meter bar 501 displaying the total funds contributed by Jack's family and friends, and a list of names of contributors for the gift packages.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the database 202g, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of gifting a recipient on a social occasion in an online gifting environment of a provider, comprising the steps of:
creating a virtual session for said social occasion by a user in said online gifting environment;
searching for gifts for said recipient from a plurality of online stores for creation of a plurality of gift packages, wherein a business relation exists between said online stores and said provider;
creating said gift packages by said user using said gifts selected from the online stores;
inviting a plurality of guests to participate in said virtual session;
posting virtual greetings to the recipient by said guests and the user in the virtual session;
contributing funds by the guests for purchase of at least one of the gift packages;
purchasing at least of one of the gift packages from the online stores using said contributed funds by the provider of the online gifting environment; and
delivering said purchased gift packages to the recipient on the social occasion;
whereby the online gifting environment enables said gifting to the recipient on the social occasion.

2. The computer implemented method of claim 1, wherein said step of creating the virtual session comprises providing name of the recipient, relationship shared with the recipient, address of the recipient, type of the social occasion, date of the social occasion, and end date for said contribution of said funds by the guests.

3. The computer implemented method of claim 1, wherein said step of creating the virtual session comprises posting a message for the guests, wherein said message is one of a text message, a multimedia message, and a combination thereof.

4. The computer implemented method of claim 1, wherein said step of inviting the guests comprises sending an electronic mail by the user to electronic mail accounts of the guests.

5. The computer implemented method of claim 4, wherein electronic mail addresses of said electronic mail accounts of the guests are procured by one of entering said electronic mail addresses in the virtual session and extracting the electronic mail addresses of the guests from an online address book of the user.

6. The computer implemented method of claim 1, wherein said virtual greetings are one or more of text greetings, picture greetings, and multimedia greetings, wherein the guests and the user upload the virtual greetings in the virtual session.

7. The computer implemented method of claim 1, wherein the virtual session comprises a meter bar, wherein said meter bar represents total funds contributed by the guests.

8. The computer implemented method of claim 1, wherein at least one of the gift packages is selected from the gift packages based on total funds contributed by the guests for said delivery.

9. The computer implemented method of claim 1, wherein at least one of the gifts is selected from a list of gifts obtained from the online stores based on total finds contributed by the guests for said delivery.

10. The computer implemented method of claim 1, wherein the user prioritizes the gifts and the gift packages to be purchased by the provider based on preferences of the recipient.

11. A computer implemented system for gifting a recipient on a social occasion in an online gifting environment, comprising:
a gift management module for managing said gifting in said online gifting environment, comprising:
a session creation engine for creating a virtual session for said social occasion by a user in said online gifting environment;
a search engine for searching for gifts for said recipient from a plurality of online stores for creation of a plurality of gift packages;
a gift package creation module for creating said gift packages by said user using said gifts selected from said online stores;
a fund collection module for collecting finds contributed by the guests for purchase of at least one of the gift packages;
a delivery engine for enabling delivery of said purchased gift packages to the recipient on the social occasion; and
a graphical user interface for inviting a plurality of guests to participate in said virtual session and for posting virtual greetings to the recipient by said guests and the user in the virtual session.

12. The computer implemented system of claim 11, wherein said gift management module further comprises an upload module for uploading virtual greetings by the guests and the user in the virtual session and for uploading text messages and multimedia messages by the user for the guests.

13. The computer implemented system of claim 11, wherein said gift management module further comprises a database for storing account information of the user, information of the recipient, information on the social occasion and said created gift packages, information on said contributed funds, said virtual greetings, text messages, and multimedia messages uploaded by the guests and the user.

14. A computer program product comprising computer executable instructions embodied in a computer-readable medium, wherein said computer program product comprises:
a first computer parsable program code for creating a virtual session for a social occasion by a user in an online gifting environment;
a second computer parsable program code for searching for gifts for a recipient from a plurality of online stores for creation of a plurality of gift packages;
a third computer parsable program code for creating said gift packages by said user using said gifts selected from said online stores;
a fourth computer parsable program code for inviting a plurality of guests to participate in said virtual session;
a fifth computer parsable program code for posting virtual greetings to said recipient by said guests and the user in the virtual session;
a sixth computer parsable program code for enabling contribution of funds by the guests for purchase of at least one of the gift packages;
a seventh computer parsable program code for purchasing at least one of the gift packages from the online stores using said contributed funds by a provider of said online gifting environment; and
an eighth computer parsable program code for enabling delivery of said purchased gift packages to the recipient on said social occasion.
